(19) United States
(12) Patent Application Publication
(10) Pub. No.: US 2022/0253045 A1
(43) Pub. Date: Aug. 11, 2022

(54) META-DATA DRIVEN MANAGEMENT SYSTEMS AND METHODS FOR FLEXIBLE MANUFACTURING

(71) Applicant: FAROBOT INC., New Taipei City (TW)

(72) Inventors: CHIA-PANG CHEN, New Taipei (TW); EDUARDO MUNERA SANCHEZ, Madrid (ES)

(21) Appl. No.: 17/369,846

(22) Filed: Jul. 7, 2021

Related U.S. Application Data
(60) Provisional application No. 63/147,175, filed on Feb. 8, 2021.

(51) Int. Cl. G05B 19/418

(52) U.S. Cl. CPC G05B 19/4185; G05B 19/4183; G05B 19/41865

(57) ABSTRACT

The application provides a meta-data driven management system and interaction method for flexible manufacturing, the system comprising: a management subsystem, an intelligent subsystem, and functional devices. The functional devices comprising devices with specific functions. Wherein, the management subsystem comprises a core module. The core module is configured to manage the meta-data driven management system. And the intelligent subsystem comprises an agent module. The agent module is configured to assist the core module in achieving dynamic operation.

### RELATED APPLICATION

This application claims priority to U.S. Provisional Patent Application No. 63/147,175 entitled METADATA DRIVEN PROTOCOL FOR FLEXIBLE MANUFACTURING filed Feb. 8, 2021 which is incorporated herein by reference for all purposes.

### TECHNICAL FIELD

The subject matter herein generally relates to industrial network.

### BACKGROUND

With a development of industrial network technology, industrial environment is becoming increasingly complicated. There exist different types of equipment in an industrial system. An industrial system set-up formed by different devices is highly complex to manage due to the increasing growth of data complexity in the system.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of a meta-data driven management system.

FIG. 2 is a diagram of another embodiment of the meta-data driven management system of FIG. 1.

FIG. 3 is a diagram of another embodiment of the meta-data driven management system of FIG. 1.

FIG. 4 is a diagram of another embodiment of the meta-data driven management system of FIG. 1.

FIG. 5 is a diagram of another embodiment of the meta-data driven management system of FIG. 1.

FIG. 6 is flowchart of an embodiment of a method for meta-data driven management.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules can be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein can be implemented as either software and/or hardware modules and can be stored in any type of computer-readable medium or other computer storage device.

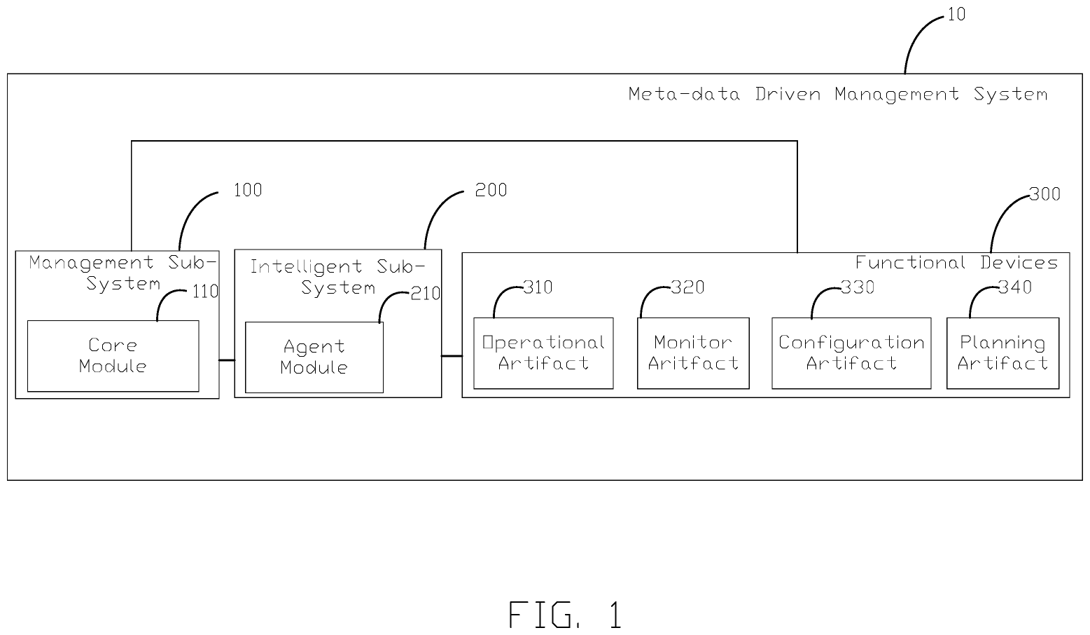

FIG. 1 illustrates a meta-data driven management system 10. The meta-data driven management system 10 includes a management sub-system 100, an intelligent sub-system 200, and functional devices 300.

The core module 110, the agent module 210, and the functional devices 300 are devices within the meta-data driven management system 10 and are classified based on the functions of the devices.

In this embodiment, the management sub-system 100 includes a core module 110. The intelligent sub-system 200 includes an agent module 210.

The core module 110 can be a server or any other device that can perform task scheduling, operation decision, resources management, and/or device control functions. The core module 110 uses the proposed meta-data driven management system 10 to perform its functions. The functions performed by the core module 110 include, but are not limited to, monitoring device status, sending operational commands, coordinating the operation of the intelligent sub-systems 200 and the functional devices 300, connecting with management software, and/or generating statistical data and reports. The management software may be, for example, a manufacturing execution system (MES) and an enterprise resource planning (ERP).

The agent module 210 is an intelligent subsystem or device with a capability of dynamic operation. For example, the intelligent device must be able to perform perception, control, and actuation tasks. The agent module 210 can be a robot or any other intelligent device capable of performing complex operations. In one embodiment, the complex operations include communication, perception, decision making, control, or actuation. In other embodiments, the complex operations include inspection of goods, picking up of goods, the transmission of goods, factory inspection tasks, and storage of goods in the warehouse.

The functional devices 300 are devices or modules that perform specific functions. The functional devices 300 are managed by the core module 110 and can interact with the agent module 210. In one embodiment, according to a specific function that the functional devices 300 perform, the functional devices 300 can be classified as an operational artifact 310, a monitor artifact 320, a configuration artifact 330, and a planning artifact 340. The operational artifact 310 can be a simple device used within an automation loop providing a specific operation function. For example, the operational artifact 310 can be a proximity sensor or a conveyor, etc. While the operational artifact 310 is a proximity sensor, the proximity sensor is used to monitor the presence of factory goods. Another example, the operational artifact 310 can be a conveyor. Although the conveyor has a plurality of functions, such as, a switching function and a function for adjusting a conveyor belt speed, its operation is specific since it cannot make an autonomous judgment, and thus can be considered as a simple device that requires an interaction to operate.

The planning device 340 is used to provide management information to the core module 110. For example, the planning artifact 340 can execute an IVIES, an ERP, a Warehouse Management System (WMS), or other software, which provides the management information. The management information includes products information to be produced, procedures to be actuated, and raw materials to be used.

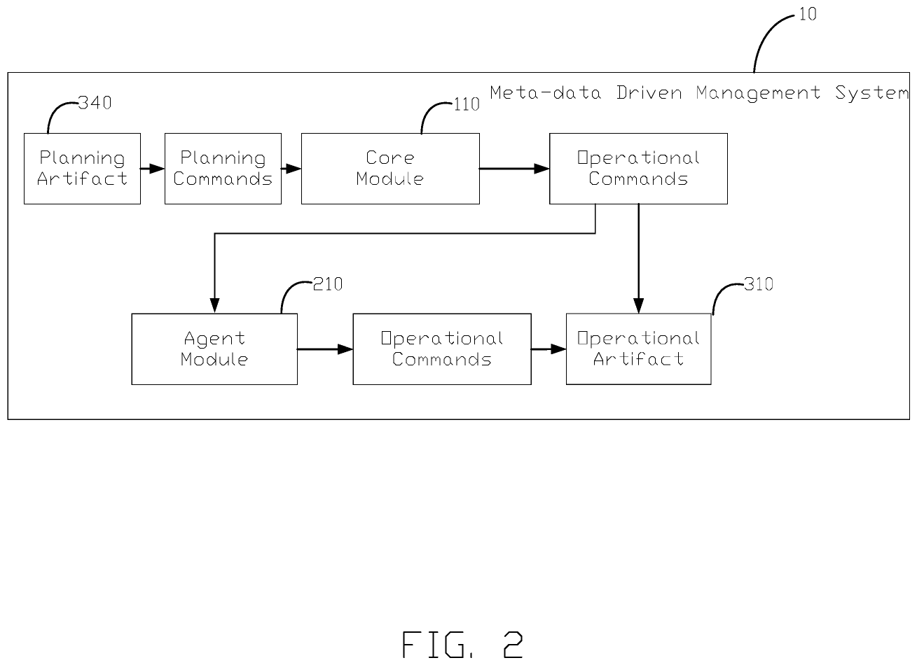

As illustrated in FIG. 2, firstly, a data type exchanged within the meta-data driven management system 10 in FIG. 2 is defined as below:

Operational Commands: the operational commands are the execution instruction generated by the core module 110. The operational commands are used to control the agent module 210 and the operational artifact 310 to carry out a corresponding operation. The operational commands can be transmitted between the core module 110, the agent module 210, and the operational artifact 310.

Planning Commands: the planning commands are generated by the planning artifact 340 according to the IVIES, the ERP, the WMS, and other systems. The planning commands are used to control the core module 110 to generate corresponding operational commands. In this embodiment, the planning commands are commands related to planning requirements, resource allocation, and execution organizations. The planning commands can be transmitted between the planning artifact 340 and the core module 110.

In detail, the planning artifact 340 triggers a set of planning commands. The core module 110 receives the planning commands. Then, the core module 110 distributes operational commands to the agent module 210 and the operational artifact 310 to execute a manufacturing operation process. The operational artifact can be controlled directly by the core module 110 or through the agent module 210.

In one embodiment, during a manufacturing process, the operational artifact 310 can only perform the manufacturing process after the agent module 210 transporting the raw material to a designated location firstly. Then, after the planning artifact 340 triggers a set of planning commands, the core module 110 receives the planning commands and distributes the operation commands to the agent module 210. The agent module 210 then triggers the operation command for the operational artifact 310. That is, the operational artifact 310 executes the manufacturing process after the intelligent module 210 has arrived at the designated location.

In one embodiment, when the operational artifact 310 can execute the manufacturing operation process directly, the core module 110 transmits an operational command to the operational artifact 310, which allows the operational artifact 310 to start a manufacturing operation process according to the received operational command.

As illustrated in FIG. 1, the functional devices 300 also at least includes a monitor artifact 320 and a configuration artifact 330. The monitor artifact 320 can be used to monitor the status of the core module 110 the agent module 210 and the remaining functional devices 300. The configuration artifact 330 can be used to set parameters and/or configurations of the remaining artifacts), the core module 110, and the agent module 210. In one embodiment, the artifact parameters can be the speed of a conveyor belt or a position of a charging station. The configuration of the core module 110 can include the edition of the factory maps, layout, and transportation routes. The configuration of the agent module 210 can include the edition of a robot name and set the maximum displacement speed.

In some embodiments, the monitor artifact 320 and the configuration artifact 330 can be any devices with a graphical user interface (GUI). The monitor artifact 320 and the configuration artifact 330 allow to visualize and/or edit parameters and configurations. For example, the monitor artifact 320 and configuration artifact 330 can be tablets, smartphones, PCs with windows interfaces, touch panels, and control panels with buttons, etc.

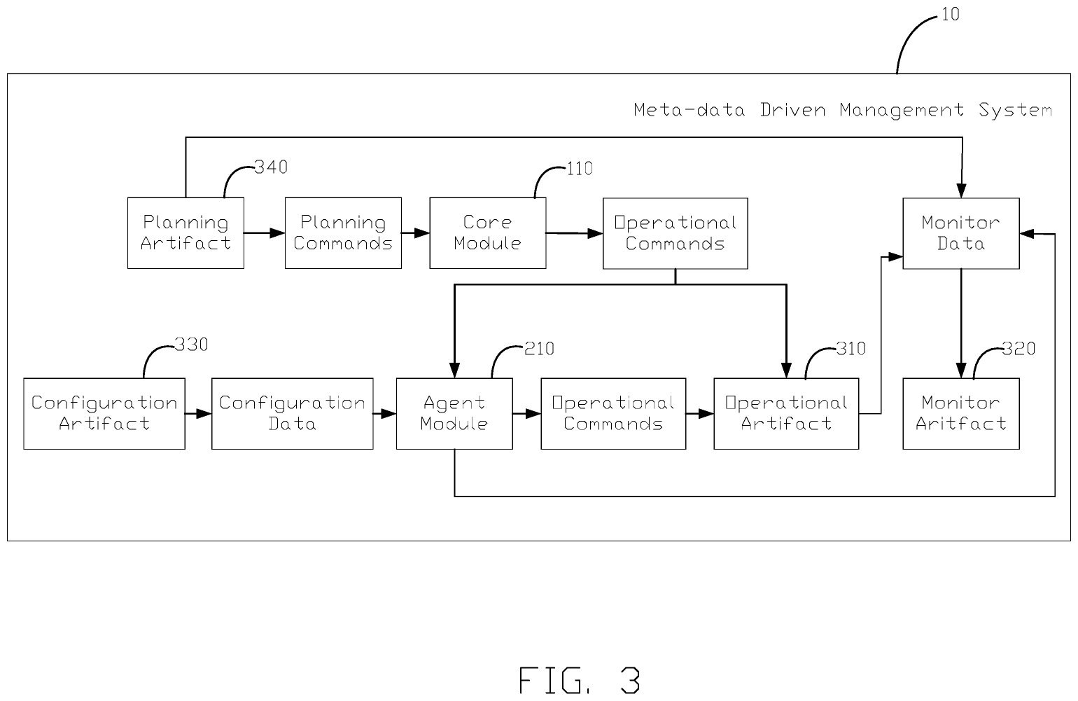

Please refer to FIG. 3, a diagram of another embodiment of the meta-data driven management system 10 of FIG. 1. Compared with FIG. 2, FIG. 3 also shows the monitor artifact 320 and the configuration artifact 330.

The data type of the meta-data driven management system 10 in FIG. 3 also includes monitor data and configuration data.

The monitor data is generated by the monitoring artifact 320 The monitoring data defines all the information related to device status, the manufacturing operation, and the environment. The monitoring data can be transmitted among the core module 110, the agent module 210, and the functional devices 300.

The configuration data is generated by the configuration artifact 330 defining the parameters of each subsystem or device within the meta-data driven management system 10. The configuration data can be transmitted among the core module 110, the agent module 210, and the functional devices 300.

In this embodiment, the topology and workflow of the core module 110, the agent module 210, the operational artifact 310, and the planning artifact 340 are similar to FIG. 2, thus will not be described in detail herein. In this embodiment, the functional devices 300 further include a monitor artifact 320 and a configuration artifact 330. The configuration artifact 330 is used to assist the setting of the configuration parameters of the core module 110. The configuration artifact 330 can also be used to assist the setting of the configuration parameters of the agent module 210. The monitor artifact 320 is designed to obtain various operation parameters (that is, monitoring data) in the manufacturing operation process, and transmit the monitoring data to each subsystem or device within the meta-data driven management system 10. The core module 110 can use monitor data to determine whether the operational command needs to be adjusted according to the monitoring data and/or the configuration data. The agent module 210 and the operational artifact 310 execute the manufacturing operation process according to the updated operational command.

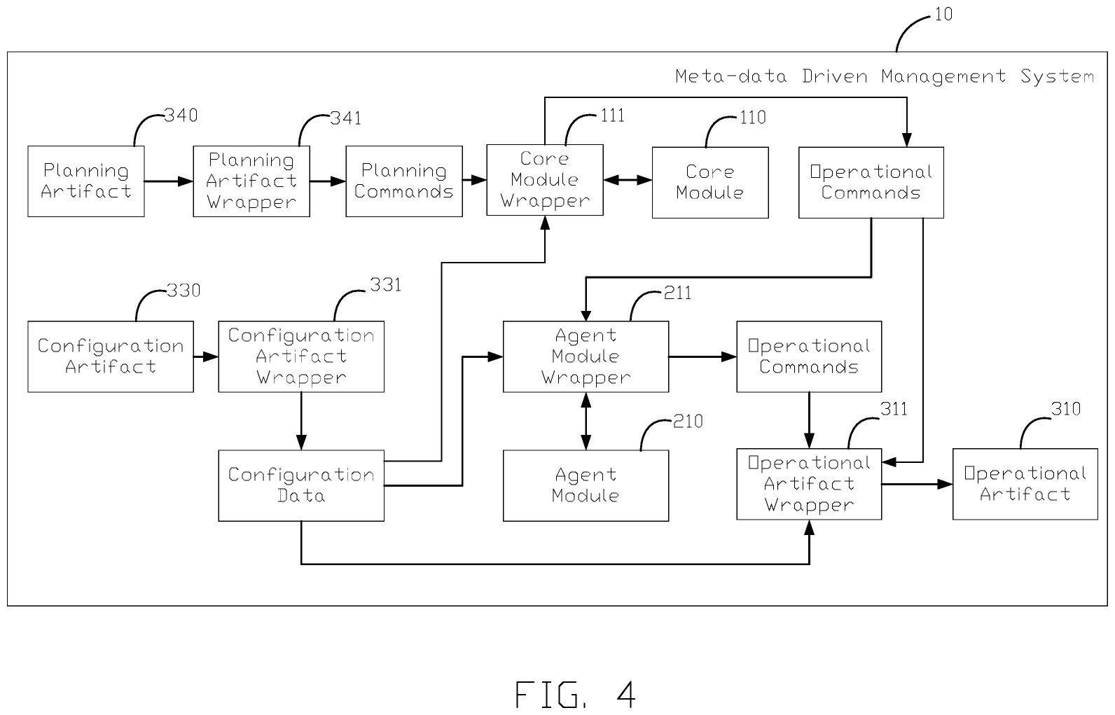

As shown in FIG. 3, the agent module 210, the operational artifact 310, the configuration artifact 330, and the planning artifact 340 are all connected to the core module 110 directly. In this embodiment, a connection manner among the agent module 210, the operational artifact 310, the configuration artifact 330, the planning artifact 340, the agent module 210, and the core module 110 is not limited. For example, as illustrated in FIG. 4, the planning artifact 340 can be connected to the core module 110 via a planning artifact wrapper 341. The configuration artifact 330 can be connected to the core module 110 and the agent module 210 via a configure artifact wrapper 331. The operational artifact 310 can be connected to the core module 110 and the agent module 210 via an operational artifact wrapper 311. The agent module 210 can be connected to the management module 110, the operational artifact 310, the configuration artifact 330, and the planning artifact 340 via an agent module wrapper 211.

In this embodiment, because some devices may use different protocols and data types, the devices may not be able to communicate with the rest of subsystems and devices within the meta-data driven management system 10. Thus, the meta-data driven management system 10 includes the use of a core module wrapper 111, an agent module wrapper 211, an operational artifact wrapper 311, a configuration artifact wrapper 331, and a planning artifact wrapper 341, which allows to connect those devices by translating their protocol and data types into the ones defined by the meta-data driven management system 10.

In this embodiment, the meta-data driven management system 10 can classify data type according to which functional device the data is generated and the function of the data, transmit the data to a certain subsystem or device according to the data type. A certain type of data only transmits between certain devices, which can reduce the complexity of the data transmission in meta-data driven management system 10. The framework of the meta-data driven management system 10 is a decentralized structure, which allows the agent module 210 to assist to generate operational commands. Instead of the management systems introduced in the related art in which the operational commands can only be generated by the management system, the meta-data driven management system 10 can deal with more complex situations. For example, the management systems in the related art would stop working if lack of raw materials to be used. Nevertheless, for the meta-data driven management system 10, after detecting a situation of lack of raw materials, the agent module 210 can suspend the operational artifact 310 by sending an operational command and wait for new raw materials. The agent module 210 can instruct the operational artifact 310 by sending an updated operational command to continue to execute the operational command after the raw materials have arrived.

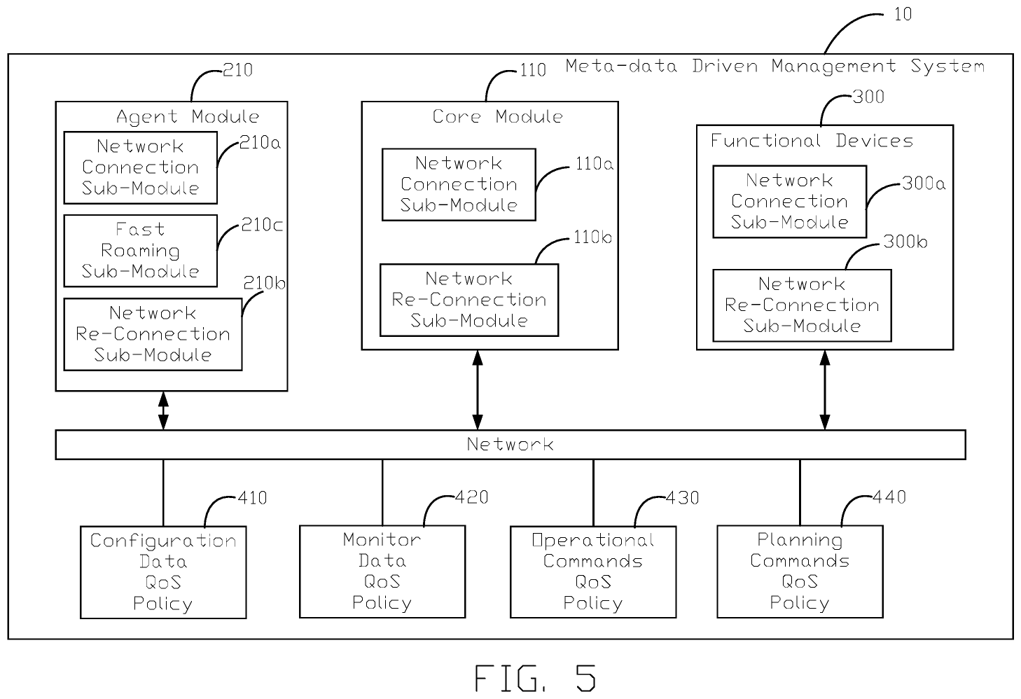

FIG. 5 illustrates a data management system 10. In one embodiment, the agent module 210, the core module 110 and the operational artifact 310, the monitor artifact 320, the configuration artifact 330, and the planning artifact 340 are all included a networking connection sub-module and a network re-connection sub-module. For example, the agent module 210 includes a networking connection sub-module 210a and a network re-connection sub-module 210b. The core module 110 includes a networking connection sub-module 110a and a network re-connection sub-module 110b. The operational artifact 310, the monitor artifact 320, the configuration artifact 330, and the planning artifact 340 includes a networking connection sub-module 300a and a network reconnection sub-module 300b. The agent module 210 is further provided with a fast roaming sub-module 210c.

In one embodiment, taking the networking connection sub-module 210a as an example, the networking connection sub-module 210a of the agent module 210 is used for discovering other agent module 210, the core module 110, and operational artifact 310, the monitor artifact 320, the configuration artifact 330 and the planning artifact 340 within the meta-data driven management system 10 and establishing a network connection. The network re-connection sub-module 210b is configured to perform network re-connection when the agent module 210 disconnects the network connection until the connection is reestablished. If the network can not be reconnected, the manufacturing operation process is stopped to avoid manufacturing accidents. The fast roaming sub-module 210c is configured to when the agent module 210 physically moves from a coverage area of an Access Point (AP) to a coverage area of another AP, quickly connect the agent module 210 to another AP. Because coverage areas of different APs partially overlap, the agent module 210 can be automatically connected to an AP with a strong signal, so as to implement a network seamless handover of the agent module 210.

In this embodiment, the networking connection module and the network reconnection module of the core module 110 and operational artifact 310, the monitor artifact 320, the configuration artifact 330, and the planning artifact 340 have the same functions as the networking connection sub-module 210a and the network reconnection sub-module 210b of the agent module 210, and are not described again herein.

In this embodiment, the core module 110 and operational artifact 310, the monitor artifact 320, the configuration artifact 330, and the planning artifact 340 generally have no mobile capability or fixed mobile path, so the fast roaming module is not required. Of course, in some embodiments, if there is a situation that the core module 110 and operational artifact 310, the monitor artifact 320, the configuration artifact 330, and the planning artifact 340 need to move between different areas, a fast roaming module can be provided to improve the network roaming capability of the core module 110 and operational artifact 310, the monitor artifact 320, the configuration artifact 330 and the planning artifact 340 during moving.

In one embodiment, the network within a meta-data driven management system 10 further includes a configuration QoS policy 500 which includes a data QoS policy 410, a monitor data QoS policy 420, an operational command QoS policy 430, and a planning command QoS policy 440. The core module 110 is configured to set up the parameters of the configuration data QoS policy 410, the monitor data QoS policy 420, the operational command QoS policy 430, and the planning command QoS policy 440. For example, when the communication deadline of the operational command QoS policy 430 is 10 ms. a time error information will be reported to the core module 110.

Obviously, since each device in the meta-data driven management system 10 adopts a distributed architecture, by setting Quality of Service (QoS) for different types of data in different subsystems and devices, communication in the system can be effectively achieved and problems such as network delay and congestion can be detected in order to act accordingly. The core module 110, the agent module 210, and operational artifact 310, the monitor artifact 320, the configuration artifact 330, and the planning artifact 340 each include the configure data QoS policy 410, the monitor data QoS policy 420, the operational command QoS policy 430, and the planning command QoS policy 440, so that they respectively have peer discovery functions and can implement ad-hoc networking, thereby effectively improving the reliability of the meta-data driven management system 10 during production.

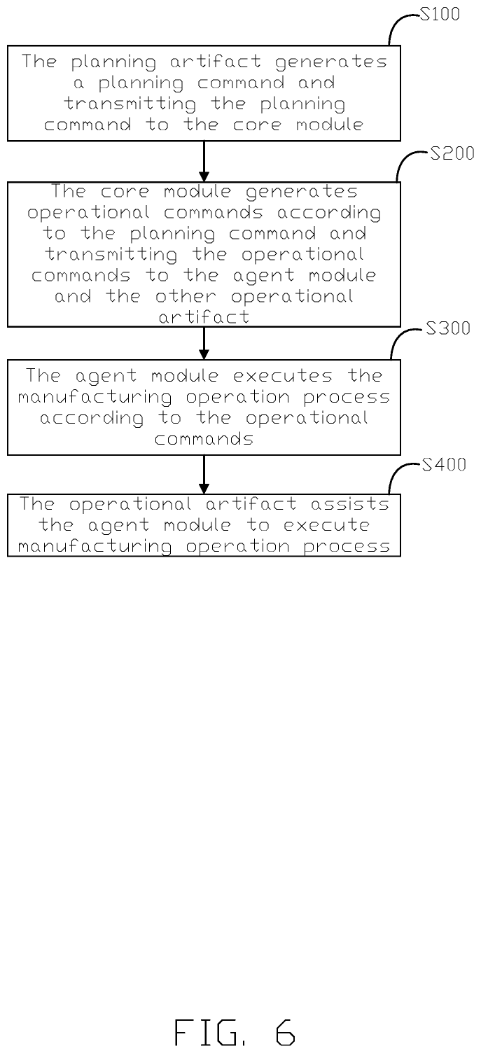

FIG. 6 illustrates a flowchart of an interaction between subsystem and devices within the meta-data driven management system 10. The method is provided by way of example, as there are a variety of ways to carry out the method. Each block shown in FIG. 6 represents one or more processes, methods, or subroutines which are carried out in the example method. Furthermore, the order of blocks is illustrative only and additional blocks can be added or fewer blocks may be utilized without departing from the scope of this disclosure.

At block S100, a planning command is generated and is transmitted.

In this embodiment, the planning command can be generated by the planning artifact 340 and is transmitted to the core module 110.

At block S200, the operational commands are generated according to the planning command and are transmitted to the agent module 210 and the operational artifact 310.

In this embodiment, the core module 110 generates the operational commands. The process of generating and transmitting an operational command is the same as the process described by the meta-data driven management system 10, which is not described in detail herein.

At block S300, the agent module 210 executes the manufacturing operation process according to the operational command.

In this embodiment, the agent module 210 executes the manufacturing operation process. The process of executing a manufacturing operation is the same as the process described by the meta-data driven management system 10, which is not described in detail herein.

At block S400, the operational artifact 310 assists the agent module 210 to execute the manufacturing operation process.

In this embodiment, the operational artifact 310 assists the agent module 210. The process of assisting the agent module 210 is the same as the process described by the meta-data driven management system 10, which is not described in detail herein.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A meta-data driven management system applied to an industrial network, the system comprising a management subsystem, an intelligent subsystem, and functional devices, the functional devices comprising devices with specific functions, wherein,
the management subsystem comprises a core module, the core module is configured to manage the meta-data driven management system; and
the intelligent subsystem comprises at least one agent module, the agent module is configured to assist the core module achieving dynamic operation.

2. The meta-data driven management system of claim 1, wherein the functional devices comprise a planning artifact and an operational artifact; and
the planning artifact is configured to generate a planning command and transmit the planning command to the core module;
the operational artifact is configured to execute the manufacturing operation process according to operational commands; wherein the operational commands are received from either the core module or the agent module.

3. The meta-data driven management system of claim 2, wherein the operational artifact is configured to execute a manufacturing operation process according to the operational commands.

4. The meta-data driven management system of claim 3, wherein the operational artifact is configured to assist the agent module to execute the manufacturing operation process.

5. The meta-data driven management system of claim 2, wherein the functional devices further comprise a monitor artifact;
wherein the monitor artifact is configured to monitor a state of the meta-data driven management system to acquire monitoring data and transmit the monitoring data to the core module.

6. The meta-data driven management system of claim 2, wherein the functional devices comprise a configuration artifact;
wherein the configure artifact is configured to set a state of the meta-data driven management system to generate configuration data and transmit the configuration data to the core module.

7. The meta-data driven management system of claim 1, further comprising a wrapper, wherein the wrapper is configured to connect one of the functional devices, the agent module, and the core module to the industrial network.

8. The meta-data driven management system of claim 1, wherein each of the core module, the agent module, and the functional devices comprises a networking connection submodule and a network reconnection submodule;
wherein the networking connection submodule is configured to discover the core module, the agent module, and the functional devices so as to carry out networking operation, the network reconnection submodule is configured to reconnect one of the functional devices, the agent module, and the core module to the industrial network.

9. The meta-data driven management system of claim 8, wherein the agent module further comprises a fast roaming submodule, the fast roaming module is configured to enable the agent module to switch the access point in the meta-data driven management system.

10. The data driven management system of claim 9, further comprising a plurality of service policies, wherein the plurality of service policies is configured to adjust a network service quality of the core module, agent module, and the functional devices.

11. An interaction method applied to a meta-data driven management system, the data management system comprising a core module, a planning artifact, an operational artifact, and an agent module, the method comprising:
the planning artifact generates a planning command and transmitting the planning command to the core module;
the core module generates operational commands according to the planning command and transmitting the operational commands to the core module and the operational artifact;
the agent module executes a manufacturing operation process according to the operational commands;
the operational artifact assists the agent module to execute the manufacturing operation process.

12. The interaction method of claim 11, further comprising:
the agent module picks and transports raw materials for executing the manufacturing operation process.

13. The interaction method of claim 11, further comprising:
a configuration artifact sets a state of the data management system to generate a configuration data and transmitting the configuration data to the core module, the agent module, and the rest of the functional devices.

14. The interaction method of claim 11, further comprising:
a monitor artifact monitors the state of the data management system to acquire monitoring data and from the agent module, the core module, and the rest of the functional devices.

15. The interaction method of claim 11, further comprising:
the planning artifact generates the planning command from any one of a manufacturing execution system, an enterprise resource planning system, and a warehouse management system.

16. The interaction method of claim 11, further comprising:
a wrapper connects one of the functional devices the agent module, and the core module to the meta-data driven management system.

17. The interaction method of claim 11, further comprising:
a networking connection submodule discovers the core module, the agent module, and the functional devices so as to carry out networking operation.

18. The interaction method of claim 17, further comprising:
a network reconnection submodule reconnects the core module, the agent module, and/or the functional devices to the meta-data driven management system.

19. The interaction method of claim 18, further comprising:
a fast roaming submodule enables the agent module to switch the access point in the industrial network.

20. The interaction method of claim 19, further comprising:
a plurality of service policies adjusts a network service quality provided by the agent module and the functional devices.
